(19) United States
(12) Patent Application Publication
(10) Pub. No.: US 2025/0362435 A1
(43) Pub. Date: Nov. 27, 2025

(54) LIGHT ABSORBER AND PREPARATION METHOD THEREOF

(71) Applicants: Tsinghua University, Beijing (CN); HON HAI PRECISION INDUSTRY CO., LTD., New Taipei (TW)

(72) Inventors: YUAN-HAO JIN, Beijing (CN); QUN-QING LI, Beijing (CN); SHOU-SHAN FAN, Beijing (CN)

(21) Appl. No.: 19/296,471

(22) Filed: Aug. 11, 2025

(30) Foreign Application Priority Data
Aug. 16, 2024 (CN) 202411132135.3

(51) Int. Cl. G02B 5/00; B82Y 20/00; B82Y 30/00; G02B 1/02

(52) U.S. Cl. CPC G02B 5/003; B82Y 20/00; B82Y 30/00; G02B 1/02

(57) ABSTRACT

A light absorber, comprises a plurality of carbon nanotubes, an epoxy resin and a plurality of carbon particles. The plurality of carbon nanotubes are connected with each other to form a carbon nanotube network structure. The epoxy resin is coated on surfaces of the plurality of carbon nanotubes. The plurality of carbon particles connected with each other by the carbon nanotube network structure coated with the epoxy resin. A method for making the light absorber is further provided.

### CROSS-REFERENCE TO RELATED APPLICATIONS

This application claims all benefits accruing under 35 U.S.C. § 119 from China Patent Application No. 202411132135.3, filed on Aug. 16, 2024, in the China National Intellectual Property Administration, the contents of which are hereby incorporated by reference.

### FIELD

The present disclosure relates to a light absorber and a preparation method thereof, and in particular to a light absorber based on carbon nanotubes and a preparation method thereof.

### BACKGROUND

Light absorbers have a wide range of applications in fields including energy collection, stray light shielding and stealth technology. In the design and manufacture of perfect light absorbers, there is often a trade-off between enhancing the micro-nanostructure density of light absorption and improving the durability and stability of materials. This dichotomy may limit the wider application of these light absorbers, especially under harsh environmental conditions. At present, there is an urgent need to design perfect light absorbers that can withstand extreme environments, including mechanical stress, extreme temperatures, strong ultraviolet radiation and other severe challenges. These light absorbers are essential for applications that require consistent performance in harsh environments, such as in aerospace, military operations and special industries.

### BRIEF DESCRIPTION OF THE DRAWINGS

Implementations of the present technology will now be described, by way of example only, with reference to the attached FIG.s, wherein:

FIG. 1 is a top view scanning electron microscope (SEM) image of a light absorber spray coating with a scale bar 500 μm provided in an embodiment of the present disclosure.

FIG. 2 is a cross-sectional SEM image of the light absorber spray coating with a scale bar 20 μm provided in an embodiment of the present disclosure.

FIG. 3 is a side SEM image of the light absorber spray coating provided in an embodiment of the present disclosure, with a scale of 500 μm.

FIG. 4 is an enlarged top view SEM image of the light absorber spray coating provided in an embodiment of the present disclosure.

FIG. 5 is an enlarged top view SEM image of the light absorber spray coating provided in an embodiment of the present disclosure.

FIG. 6 is an SEM image of a sprayed carbon nanotube-carbon black composite material without epoxy resin.

FIG. 7 is a transmission electron microscope (TEM) image of carbon nanotubes and epoxy resin dispersed in an ethanol solution provided in an embodiment of the present disclosure.

FIG. 8 is a schematic flow chart of a method for preparing a light absorber provided in an embodiment of the present disclosure.

FIG. 9 is a reflection spectrum of the light absorber provided in the present disclosure in a visible light wavelength range.

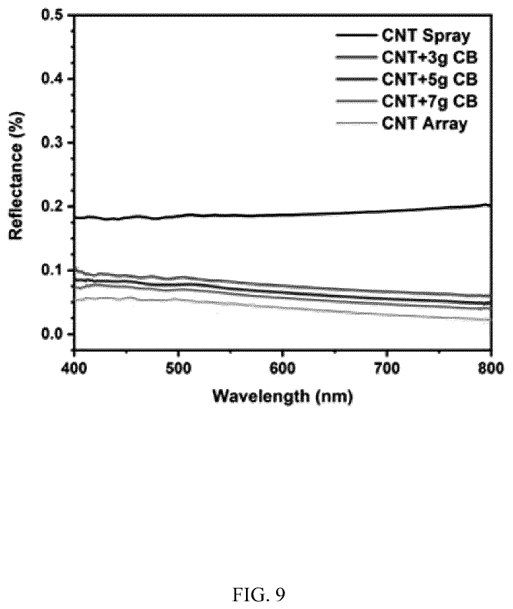

FIG. 10 is a reflection spectrum of the light absorber provided in the present disclosure in a near-infrared wavelength range.

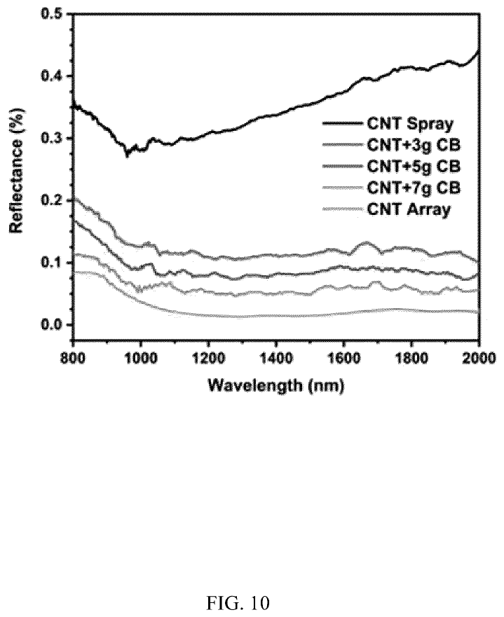

FIG. 11 is a reflection spectrum of the light absorber provided in the present disclosure in a mid-infrared wavelength range.

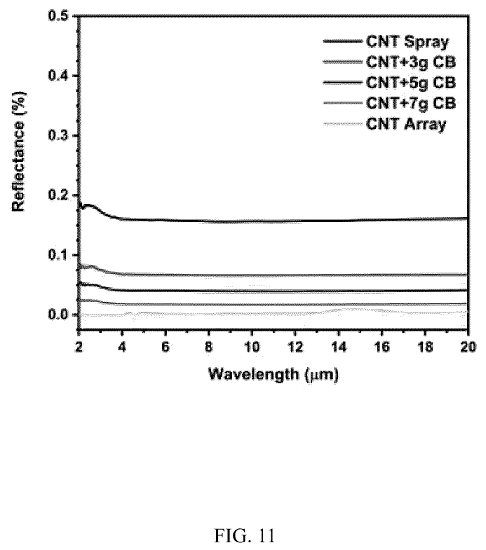

FIG. 12 is a functional relationship between a specular reflectivity and an incident angle of the light absorber provided in the present disclosure, measured using non-polarized light with a wavelength of 550 nm.

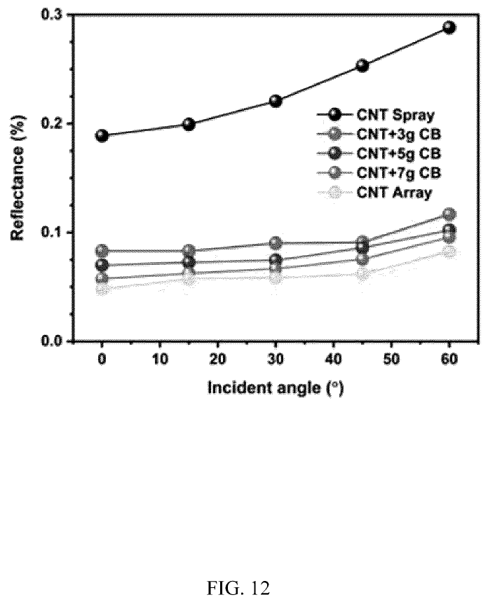

FIG. 13 is a hemispherical reflection spectrum of the light absorber provided in the present disclosure, measured by an integrating sphere in the visible light wavelength range.

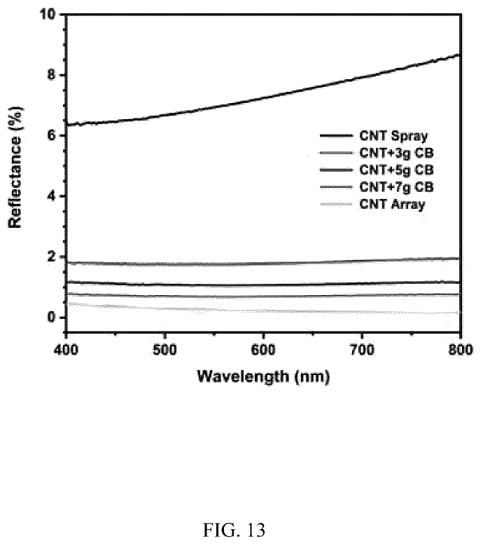

FIG. 14 is a hemispherical reflection spectrum of the light absorber provided in the present disclosure, measured by an integrating sphere in the near-infrared wavelength range.

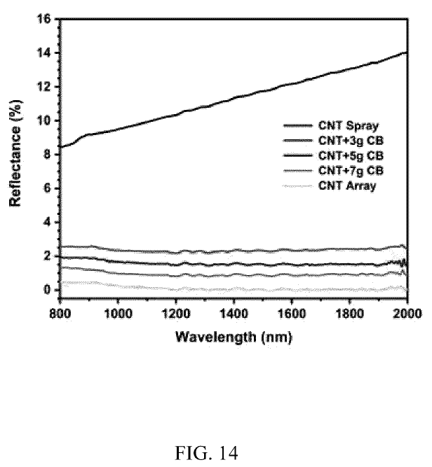

FIG. 15 is a reflection spectrum of the light absorber provided by the present disclosure, measured at an incident angle of 15°.

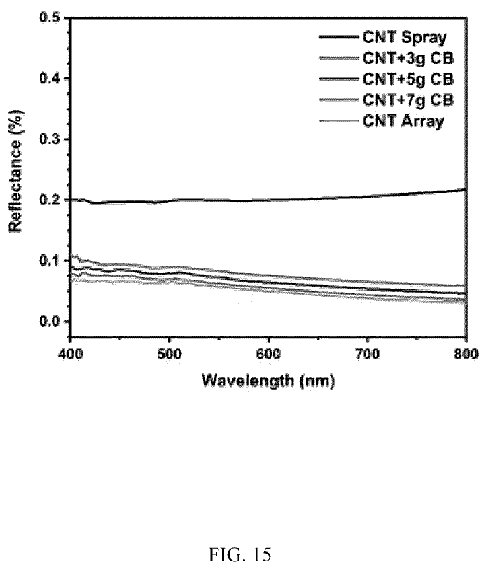

FIG. 16 is a reflection spectrum of the light absorber provided by the present disclosure, measured at an incident angle of 30 degrees.

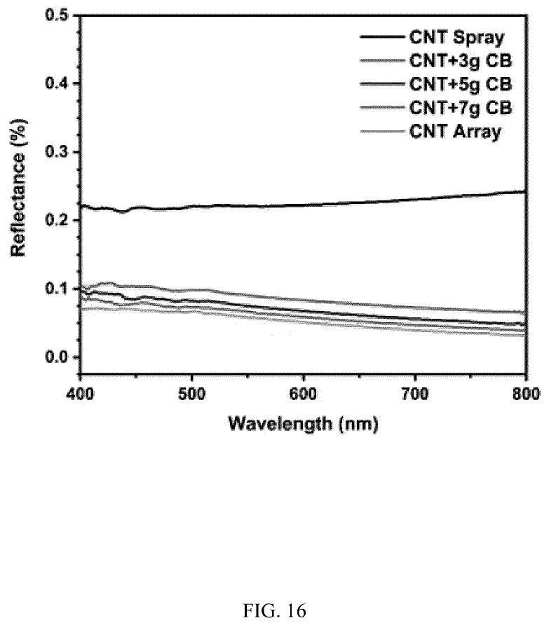

FIG. 17 is a reflection spectrum of the light absorber provided by the present disclosure, measured at an incident angle of 45 degrees.

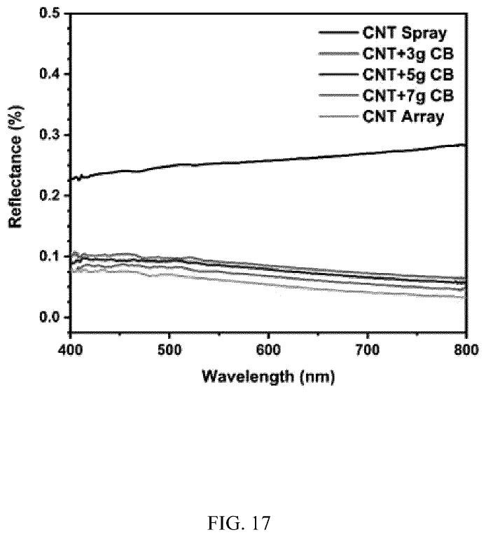

FIG. 18 is a reflection spectrum of the light absorber provided by the present disclosure, measured at an incident angle of 60°.

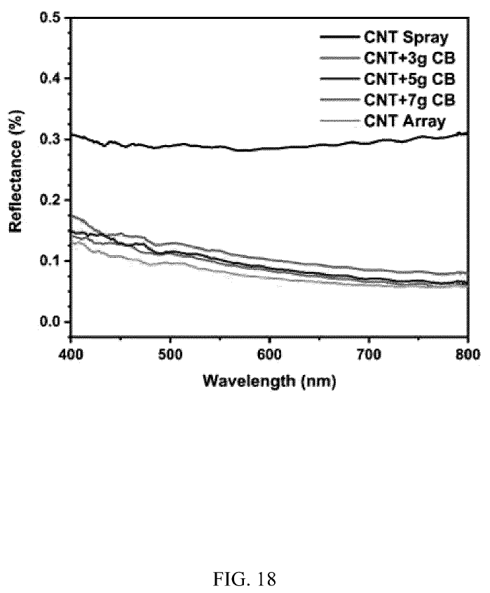

FIG. 19 is a schematic diagram of the bonding mechanism between carbon black particles and carbon nanotubes added with epoxy resin in the light absorber spray layer provided by the present disclosure.

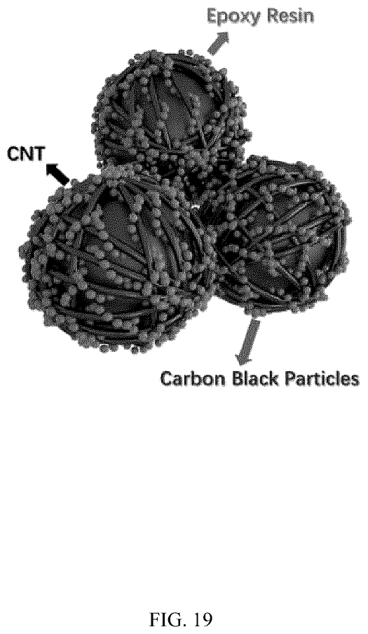

FIG. 20 is a schematic diagram of the comparison before and after a scratch area of the light absorber spray layer is adhered with tape in an embodiment of the present disclosure.

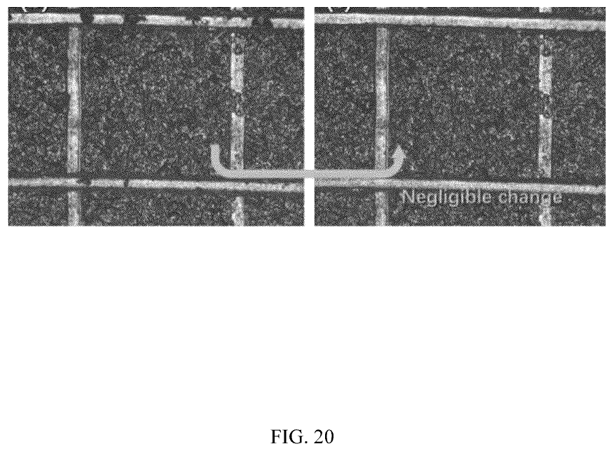

FIG. 21 is a photo of the wear track of the carbon nanotube-CB particle layer without epoxy resin added in an embodiment of the present disclosure, after 500 wear cycles.

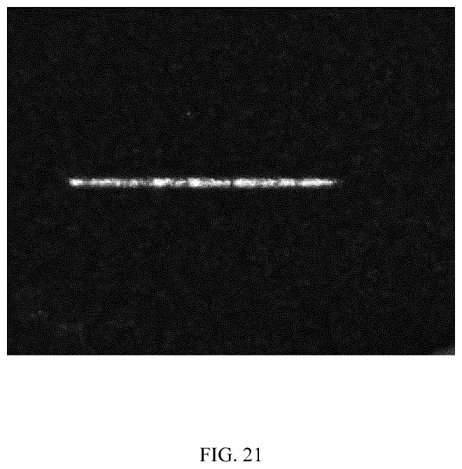

FIG. 22 is a microscope image of the wear track of the carbon nanotube-CB particle layer without epoxy resin added in an embodiment of the present disclosure, after 500 wear cycles.

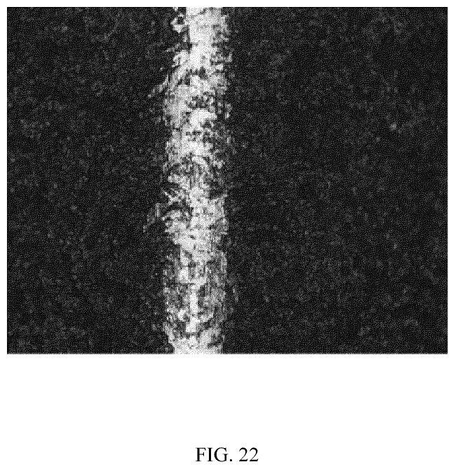

FIG. 23 is a photograph of a wear track of the light absorber spray coating provided in an embodiment of the present disclosure, after 500 wear cycles.

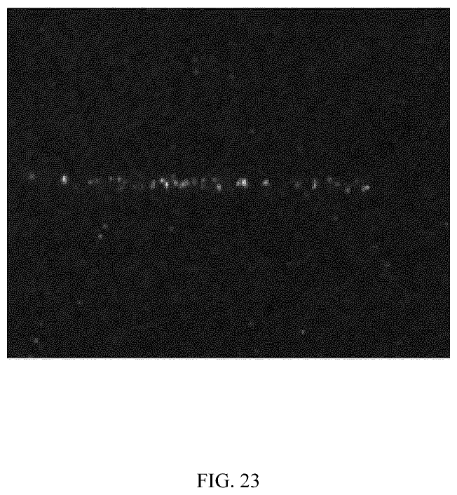

FIG. 24 is a microscope image of the wear track of the light absorber spray coating provided in an embodiment of the present disclosure, after 500 wear cycles.

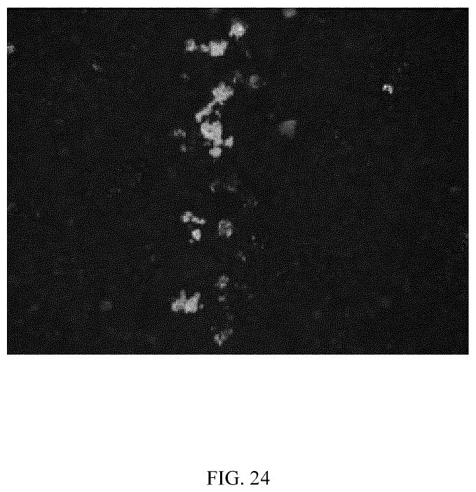

FIG. 25 is a schematic diagram of using sandpaper to perform a linear wear test on the light absorber spray coating provided in an embodiment of the present disclosure.

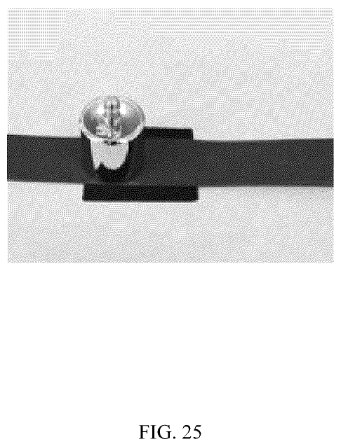

FIG. 26 is a schematic diagram of preparing a spray coating on a cloth as a light absorber.

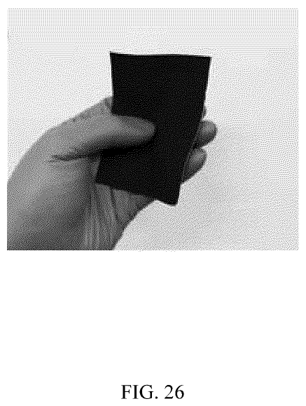

FIG. 27 is a schematic diagram of testing the specular reflectivity of the light absorber spray coating of this embodiment under a harsh environment with a wavelength of 550 nm.

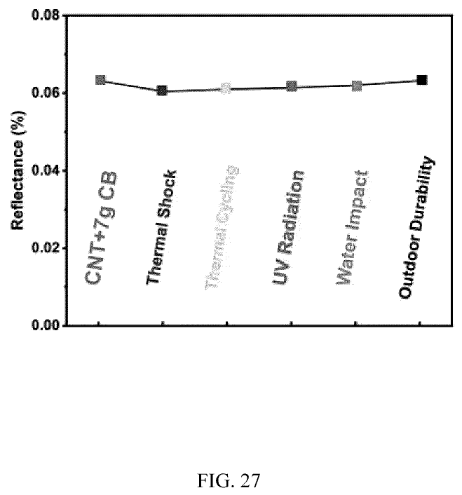

### DETAILED DESCRIPTION

The disclosure is illustrated by way of example and not by way of limitation in the FIG.s of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different FIG.S to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “comprise, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly comprise at least one of the features. The term of “multiple times” means at least two times, such as two times, three times, etc., unless otherwise expressly and specifically defined.

The present invention provides a light absorber, which comprises a plurality of carbon nanotubes, a plurality of carbon particles and an epoxy resin. The plurality of carbon nanotubes form a carbon nanotube network structure, the epoxy resin is coated on surface of the plurality of carbon nanotubes, and the plurality of carbon particles are connected by the epoxy resin and the carbon nanotube network structure. That is, the plurality of carbon particles are connected by the carbon nanotube network structure coated with epoxy resin, the carbon particles are wrapped by carbon nanotubes and epoxy resin, and there are gaps between carbon nanotube-carbon particle aggregates. Adding epoxy resin to the light absorber significantly enhances the connection between carbon nanotubes and carbon particles, and the addition of epoxy resin significantly strengthens the interface bonding between carbon nanotubes and carbon particles. The carbon nanotubes can be single-walled carbon nanotubes, double-walled carbon nanotubes or multi-walled carbon nanotubes. The carbon particles can be carbon particles with a diameter range of 100 nm-100 μm. The epoxy resin can be bisphenol A epoxy resin, bisphenol F epoxy resin, bisphenol S epoxy resin, novolac epoxy resin, multifunctional glycidyl ether epoxy resin and other alcohol-soluble epoxy resins.

Further, the light absorber can also comprise a substrate for supporting the light absorber. A type, shape, thickness, etc. of the substrate are not limited. The substrate may be quartz, polymer, metal, ceramic or cloth, etc. A surface of the substrate may be a plane, a curved surface, or an irregular surface. In this embodiment, the substrate is quartz.

Further, the light absorber may also comprise a curing agent, which is selected according to the corresponding epoxy resin, and can be a fatty amine, an aromatic amine, a polyamide, etc.

In one embodiment, the light absorber comprises a plurality of carbon nanotubes, a plurality of carbon particles, an epoxy resin, and a curing agent. The carbon nanotubes are multi-walled carbon nanotubes with an average diameter of 20 nanometers. The carbon particles are carbon black (CB) particles, the epoxy resin is E51, and the curing agent is diethylenetriamine.

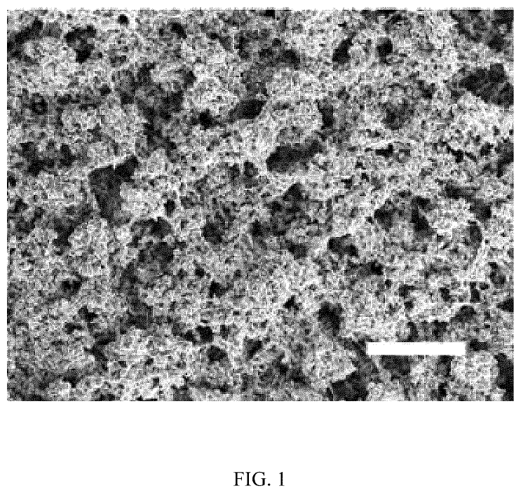

As shown in FIG. 1, a morphology of the light absorber spray coating of this embodiment is very similar to that of the light absorber spray coating without epoxy resin, the carbon black particles are evenly dispersed on the surface of the light absorber, and the carbon nanotube-carbon black composite material widely covers the light absorber spray coating. This observation suggests that carbon nanotube-CB particle composite coatings can be fabricated by spraying process by adding appropriate epoxy resin and curing agent. This method maintains the full carbon nanomaterial system and its surface morphology, laying the foundation for superior absorption characteristics and ensuring the stability and durability of the light absorber spray coating.

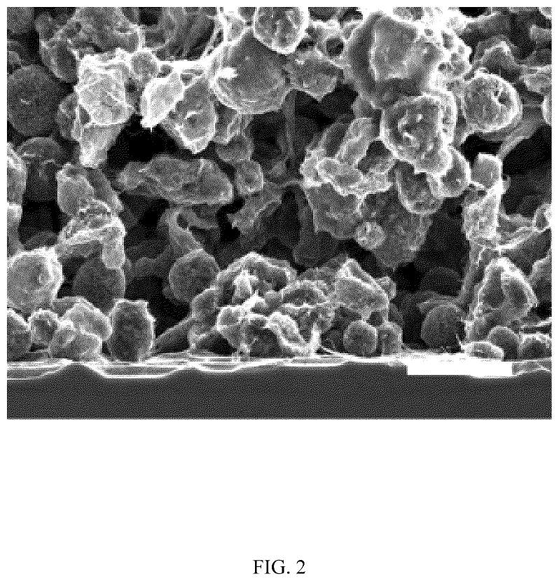

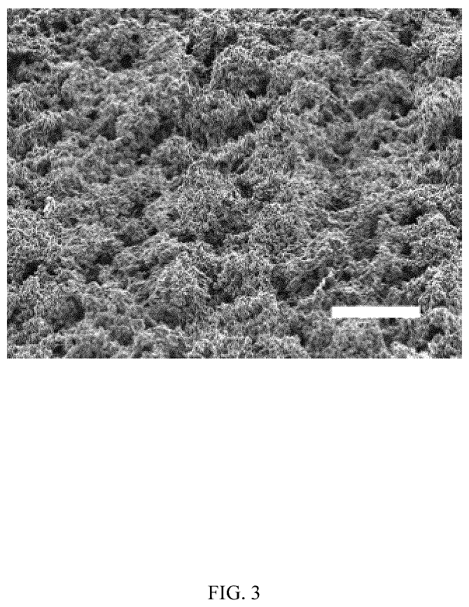

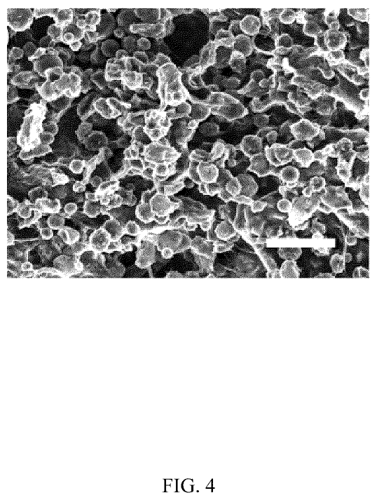

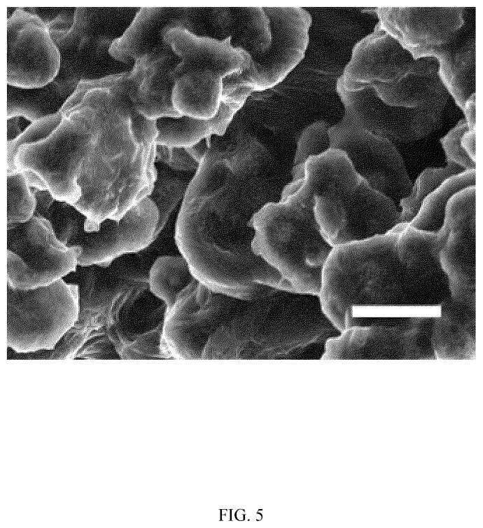

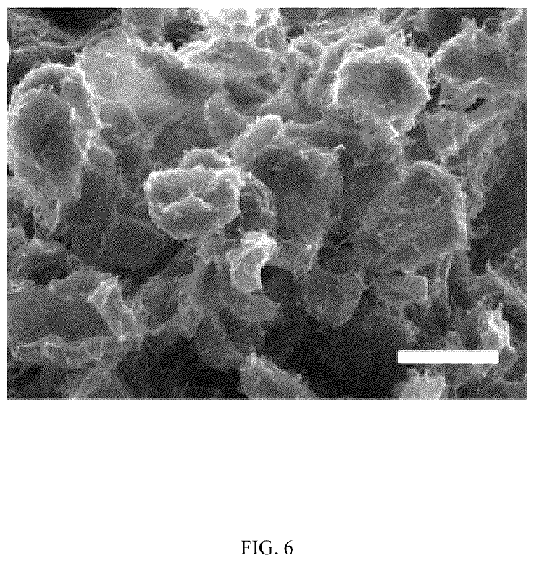

As shown in FIG. 2, a cross-sectional view of the light absorber spray coating reveals that the CB particles are encapsulated by carbon nanotubes and epoxy resin. The light absorber composite is closely arranged to establish a layered structure, and this configuration is like bricks bonded with mortar, in which the CB particles are connected by the carbon nanotube network integrated with the resin. Such a network gives the light absorber spray coating strong mechanical properties and stability. The side view SEM image of the light absorber spray coating presented in FIG. 3 depicts an undulating and uniform topography with gaps between carbon nanotube-CB aggregates. These gaps are tens of nanometers, which are very advantageous for light absorption in the visible to infrared spectral range. In addition, from the perspective of light absorber design, the integration of CB particles enhances the scattering and absorption capabilities of the light absorber surface. As shown in FIG. 4, the surface morphology of the light absorber spray coating is characterized by stacked carbon nanotube-CB particle composites with gaps between them. The integration of these particles, especially in the all-carbon nanomaterial, effectively increases the gap density in the local area. This increase in gap density effectively reduces the equivalent refractive index of the light absorber surface, thereby promoting the reduction of reflection. In addition, the addition of epoxy resin in the carbon nanotube-CB particle composite produces unique properties that are not observed in the resin-free layer, as shown in FIG. 5. The presence of epoxy resin gives the carbon nanotube-CB particles a smoother surface texture, indicating that the carbon nanotubes and CB particles are fully encapsulated by the resin, a feature further demonstrated by the image of the resin-free spray coating presented in FIG. 6.

The carbon nanotubes exhibit high efficiency as absorbers and connectors connecting carbon particles within the light absorber coating, thereby creating a multi-scale, all-carbon-based nanomaterial.

It is understood that the light absorber can be composed of multiple carbon nanotubes (CNTs), multiple carbon particles, and epoxy resin.

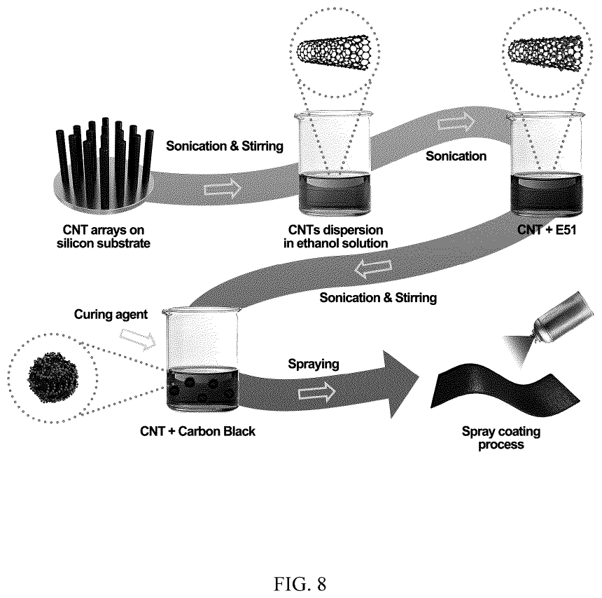

In addition, referring to FIG. 8, an embodiment of the present invention provides a method for preparing a light absorber, which comprises the following steps:
S1, providing a light absorber prefabricated liquid, the light absorber prefabricated liquid comprises a solvent, a plurality of carbon nanotubes, a plurality of carbon particles and epoxy resin, the plurality of carbon nanotubes form a network structure, and the carbon nanotubes and carbon particles are suspended in the solvent in a colloidal state;
S2, spraying the light absorber prefabricated liquid on a substrate to form a light absorber.

In the light absorber prefabricated liquid, the carbon nanotubes and carbon particles show the ability to remain stable for a long time, sometimes even for several months, without forming aggregates.

In step S1, the method for preparing the light absorber prefabricated liquid comprises the following steps:
S11, providing a plurality of carbon nanotubes;
S12, dispersing the plurality of carbon nanotubes in a solvent, performing flocculation treatment, and obtaining a carbon nanotube suspension;
S13, adding epoxy resin and carbon particles to the carbon nanotube suspension, performing ultrasonic dispersion, and forming a light absorber prefabricated liquid.

In step S11, the preparation method of carbon nanotubes is not limited, such as arc discharge method, laser evaporation method, or chemical vapor deposition method. In this embodiment, carbon nanotubes are prepared by chemical vapor deposition method, which comprises the following steps:
S111, growing a carbon nanotube array on a growth substrate; and
S112, scraping the carbon nanotube array from the growth substrate using a blade or other tool to obtain multiple carbon nanotubes.

In step S111, the length of the plurality of carbon nanotubes in the carbon nanotube array is not limited. Preferably, the length of the carbon nanotube is greater than 100 μm (micrometer). The plurality of carbon nanotubes are substantially parallel to each other and substantially perpendicular to the surface of the growth substrate. The carbon nanotube array provided in this embodiment is one of a single-walled carbon nanotube array, a double-walled carbon nanotube array, and a multi-walled carbon nanotube array.

In one embodiment, the preparation method of the carbon nanotube array adopts chemical vapor deposition, and its specific steps comprise: (a) providing a flat growth substrate, which can be a P-type or N-type silicon substrate, or a silicon substrate with an oxide layer formed thereon. In this embodiment, an 8-inch silicon substrate is preferably used; (b) a catalyst layer is uniformly formed on the surface of the growth substrate, and the catalyst layer material can be iron (Fe), cobalt (Co), nickel (Ni) or any combination of alloys thereof; (c) the growth substrate with the catalyst layer formed thereon is annealed in air at 700° C. to 900° C. for about 30 minutes to 90 minutes; (d) the treated growth substrate is placed in a reaction furnace, heated to 500° C. to 740° C. under a protective gas environment, and then a carbon source gas is introduced to react for about 5 minutes to 30 minutes to grow a carbon nanotube array, the height of which is greater than 100 microns. The carbon nanotube array is a pure carbon nanotube array formed by a plurality of carbon nanotubes that grow parallel to each other and perpendicular to the growth substrate. Since the generated carbon nanotubes are relatively long, some of the carbon nanotubes may be entangled with each other. By controlling the growth conditions as described above, the carbon nanotube array contains substantially no impurities, such as amorphous carbon or residual catalyst metal particles. In this embodiment, the carbon source gas may be a hydrocarbon with relatively active chemical properties, such as acetylene, and the protective gas may be nitrogen, ammonia or an inert gas.

In step S12, the plurality of carbon nanotubes are dispersed in a solvent, and the flocculation treatment may be performed by ultrasonic dispersion treatment or high-intensity stirring to obtain a carbon nanotube suspension. Preferably, the plurality of carbon nanotubes are dispersed in an ethanol solvent and ultrasonic dispersion is performed for 10 to 30 minutes. Since carbon nanotubes have a large specific surface area and there is a large van der Waals force between the intertwined carbon nanotubes, the flocculation treatment does not completely disperse the carbon nanotubes in the carbon nanotube raw material in the solvent. The carbon nanotubes are attracted and entangled with each other by van der Waals forces to form a network structure, which may also be called a flocculent structure. In this embodiment, the carbon nanotubes are dispersed in an ethanol solution, and the carbon nanotubes are interconnected to form a network structure. It is necessary to maintain the colloidal suspension state of carbon nanotubes in the ethanol solvent. A higher carbon nanotube concentration may increase the viscosity of the solution, which may impair the subsequent spraying process, while a lower carbon nanotube concentration may reduce the efficiency of light absorber preparation. Preferably, 0.1-0.8 grams of carbon nanotubes are dispersed in every 200 milliliters of ethanol.

In step S12, preferably, a dispersant may be added during the process of dispersing the plurality of carbon nanotubes into the solvent, and then the carbon nanotubes are dispersed by tip ultrasonication using an ultrasonic cell disruptor to form a carbon nanotube suspension.

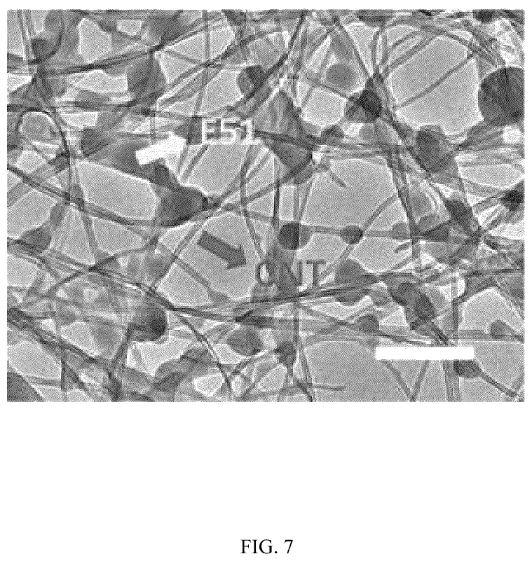

In step S13, after epoxy resin is added to the carbon nanotube suspension and fully mixed, the epoxy resin is evenly distributed between the carbon nanotubes, as shown in FIG. 7. Obviously, the carbon nanotubes are surrounded by epoxy resin, and the epoxy resin accumulates at the joints of the carbon nanotubes to form a uniform composite material of carbon nanotubes and epoxy resin, which is crucial to the structural integrity and performance of the light absorber. The epoxy resin is added to the carbon nanotube suspension as a binder, and the dispersion of the carbon nanotubes in the epoxy resin is crucial to enhancing the stability and durability of the light absorber. Proper dispersion techniques can ensure that the epoxy resin is uniformly distributed throughout the carbon nanotube suspension.

It is to be understood that the above-described embodiments are intended to illustrate rather than limit the present disclosure. Variations can be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described can be removed, others can be added, and the sequence of steps can be altered. The description and the claims drawn to a method may comprise some indication in reference to certain steps. However, the indication used is only to be viewed for identification purposes and not as a suggestion as to an order for the steps.

What is claimed is:

1. A light absorber, comprising:
a plurality of carbon nanotubes connected with each other to form a carbon nanotube network structure;
an epoxy resin coated on surfaces of the plurality of carbon nanotubes; and
a plurality of carbon particles connected with each other by the carbon nanotube network structure coated with the epoxy resin.

2. The light absorber of claim 1, further comprising a plurality of gaps in the light absorber.

3. The light absorber of claim 1, further comprising a curing agent.

4. The light absorber of claim 1, further comprising a substrate, wherein the plurality of carbon nanotubes, the plurality of carbon particles and the epoxy resin are on the surface of the substrate.

5. The light absorber of claim 4, wherein a surface of the substrate is a plane surface, a curved surface, or an irregular surface.

6. The light absorber of claim 1, wherein the light absorber consists of the plurality of carbon nanotubes, the plurality of carbon particles and the epoxy resin.

7. The light absorber of claim 1, wherein a mass ratio of the plurality of carbon nanotubes to the plurality of carbon particles is ranged from 4:5 to 4:70.

8. A method of preparing a light absorber, comprising:
making a light absorber prefabricated liquid, the light absorber prefabricated liquid comprising a solvent, a plurality of carbon nanotubes, a plurality of carbon particles and epoxy resin, wherein the plurality of carbon nanotubes and plurality of carbon particles are suspended in the solvent in a colloidal state; and
spraying the light absorber prefabricated liquid on a substrate to form a light absorber.

9. The method of claim 8, wherein making the light absorber prefabricated liquid comprises:
making the plurality of carbon nanotubes;
dispersing the plurality of carbon nanotubes in the solvent to form a carbon nanotube suspension; and
adding the epoxy resin and the plurality of carbon particles to the carbon nanotube suspension, and dispersing them to form the light absorber prefabricated liquid.

10. The method of claim 8, wherein a mass ratio of the plurality of carbon nanotubes to the plurality of carbon particles is ranged from 4:5 to 4:70.

11. The method of claim 8, wherein a weight of the epoxy resin is ranged from 0.1 g to 0.4 g in per 200 ml of the solvent.
